(19) United States
(12) Patent Application Publication
(10) Pub. No.: US 2014/0116100 A1
(43) Pub. Date: May 1, 2014

(54) SMART DOOR UNLOCK SYSTEM

(71) Applicant: HYUNDAI MOTOR COMPANY, Seoul (KR)

(72) Inventors: Jae Sueng Lee, Hwaseong-si (KR); Eui Chan Cho, Suwon-si (KR)

(73) Assignee: Hyundai Motor Company, Seoul (KR)

(21) Appl. No.: 13/738,573

(22) Filed: Jan. 10, 2013

(30) Foreign Application Priority Data
Nov. 1, 2012 (KR) 10-2012-0122920

(51) Int. Cl. E05B 65/12

(52) U.S. Cl. CPC E05B 77/22; E05B 77/48
USPC 70/264

(57) ABSTRACT

A smart door unlock system may include a lock cylinder with a rotor receivably having a key inserted thereinto and rotated and a connecting rod rotated together with the rotor, an ignition switch provided with lock LOCK, accessory ACC, on ON, or start START switches, and outputting a signal of an operation state when the rotor is rotated with the key inserted thereinto and the connecting rod is positioned at any one of the switches, a body control module (BCM) automatically locking or unlocking a door or doors according to the signal output from the ignition switch when the connecting rod is positioned at the lock LOCK. The lock LOCK of the ignition switch includes a first lock for locking all doors, a second lock for unlocking only a driver's side door, and a third lock for unlocking all doors.

### CROSS-REFERENCE TO RELATED APPLICATION

The present application claims priority of Korean Patent Application Number 10-2012-122920, filed on Nov. 1, 2012, the entire contents of which application is incorporated herein for all purposes by this reference.

### BACKGROUND OF INVENTION

1. Field of Invention

The present invention relates to a smart door unlock system, and more particularly, to a smart door unlock system capable of selectively unlocking a door at the time of separation of a key.

2. Description of Related Art

Generally, all doors of a vehicle are unlocked in a process in which a driver stops or parks the vehicle after driving the vehicle and then turns off an ignition. In the state in which the doors are unlocked as described above, a vehicle key is separated.

That is, in a door unlock system according to the related art, as shown in FIG. 1, after the vehicle is stopped or parked, when a vehicle key 10 is rotated from a start position to a lock position in the state in which it is inserted into a rotor 21 of a lock cylinder 20, the ignition is turned off, and at the same time, all doors are in an unlock state, such that the driver and all passengers may open the doors and then get off the vehicle.

However, in the door unlock system according to the related art, when the ignition of the vehicle is turned off regardless of an intention of the driver, since all doors are in the unlock state, in the case in which a robber invades the vehicle through a door of a passenger side, the driver is exposed to a risk.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention are directed to provide a smart door unlock system capable of improving security by implementing a system allowing a driver to selectively unlock a door.

Various aspects of the present invention provide a smart door unlock system including a lock cylinder including a rotor receivably having a key inserted thereinto and rotated and a connecting rod rotated together with the rotor, an ignition switch provided with lock LOCK, accessory ACC, on ON, or start START switches, and outputting a signal of an operation state when the rotor is rotated with the key inserted thereinto and the connecting rod is positioned at any one of the switches, a body control module (BCM) automatically locking or unlocking a door or doors according to the signal output from the ignition switch when the connecting rod is positioned at the lock LOCK. The lock LOCK of the ignition switch includes a first lock for locking all doors, a second lock for unlocking only a driver's side door, and a third lock for unlocking all doors.

In the case of separating the key when the connecting rod is positioned at the first lock, an ignition may be turned off, and at the same time, the BCM may maintain all doors in a lock state so as not to be opened.

In the case of separating the key when the connecting rod is positioned at the second lock, an ignition may be turned off, and at the same time, the BCM may automatically unlock only the driver's side door so as to be opened and maintain other doors in a lock state so as not to be opened.

In the case of separating the key when the connecting rod is positioned at the third lock, an ignition may be turned off, and at the same time, the BCM may automatically unlock all doors so as to be opened.

The lock cylinder may include symbols displaying the first lock, the second lock, and/or the third lock of the lock LOCK.

The smart door unlock system may further include a catching jaw or catching jaws formed between the first lock and the second lock or between the second lock and the third lock

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The above and other features of the present invention will now be described in detail with reference to certain exemplary embodiments thereof illustrated in the accompanying drawings which are given herein below by way of illustration only, and thus are not limitative of the present invention, and wherein:

FIG. 1 is a view showing a door unlock system according to the related art;

FIG. 2 is a perspective view showing a structure of an exemplary door unlock system according to the present invention;

FIG. 3 is a front view showing the structure of an exemplary door unlock system according to the present invention;

FIG. 4 is a cross-sectional view taken along the line A-A of FIG. 2;

FIGS. 5A to 5C are views showing logics of an exemplary door unlock system according to the present invention;

FIG. 6 is a view of an exemplary ignition switch pin structure according to the present invention; and

FIG. 7 is a view showing another exemplary door unlock system according to the present invention.

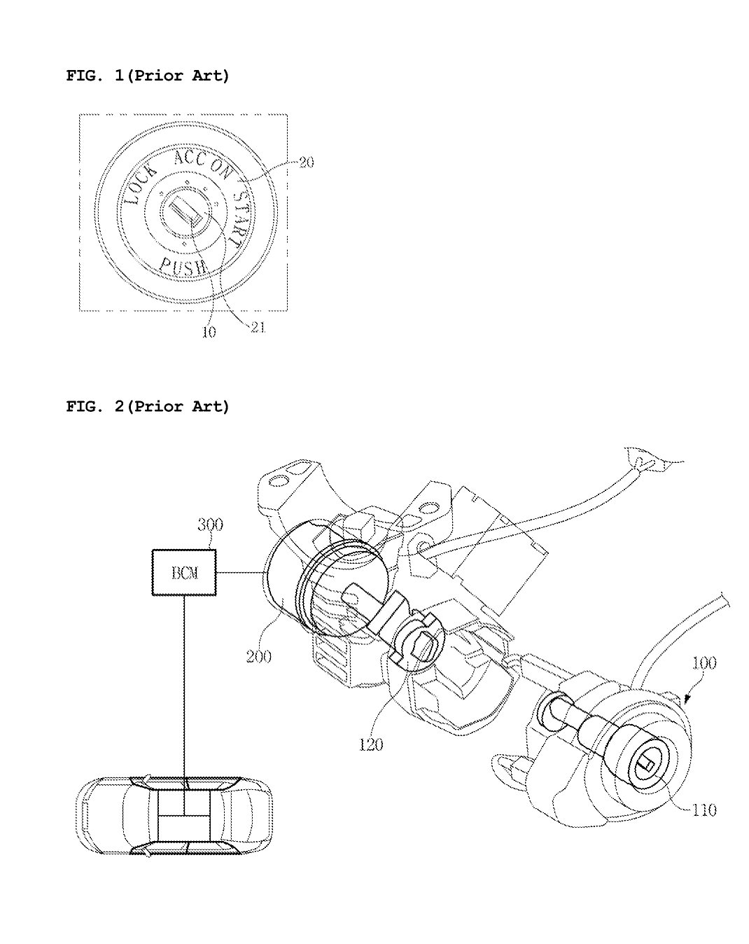

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

A smart door unlock system according to various embodiments of the present invention is a system including a function of selecting one among lock of all doors, unlock of only a driver's side door, and unlock of all doors at the time of separation of a key to unlock the door as needed by a driver, thereby improving security and marketability.

Referring to FIG. 2, a smart door unlock system according to various embodiments of the present invention is configured to include a lock cylinder 100 including a rotor 110 having a key inserted thereinto and rotated and a connecting rod 120 rotated together with the rotor 110, an ignition switch 200 provided with lock LOCK, accessory ACC, on ON, and start START switches at any one of which the connecting rod 120 is positioned when the rotor 110 is rotated in the state in which it has the key inserted thereinto, thereby outputting a signal of an operation state, and a body control module (BCM) 300 automatically unlocking a door according to the signal output from the ignition switch 200 when the connecting rod 120 is positioned at the lock LOCK.

That is, in the smart door unlock system according to various embodiments of the present invention, when the rotor is rotated in the state in which it has the key inserted thereinto, the connecting rod 120 is rotated together with the rotor 110. In this case, the connecting rod 120 is positioned at any one of the lock LOCK, the accessory ACC, the on ON, and the start START switches provided in the ignition switch 200 to output a signal of the operation state. Here, when the connecting rod 120 is positioned at the lock LOCK, the BCM 300 automatically unlocks the door based on the signal output from the ignition switch 200.

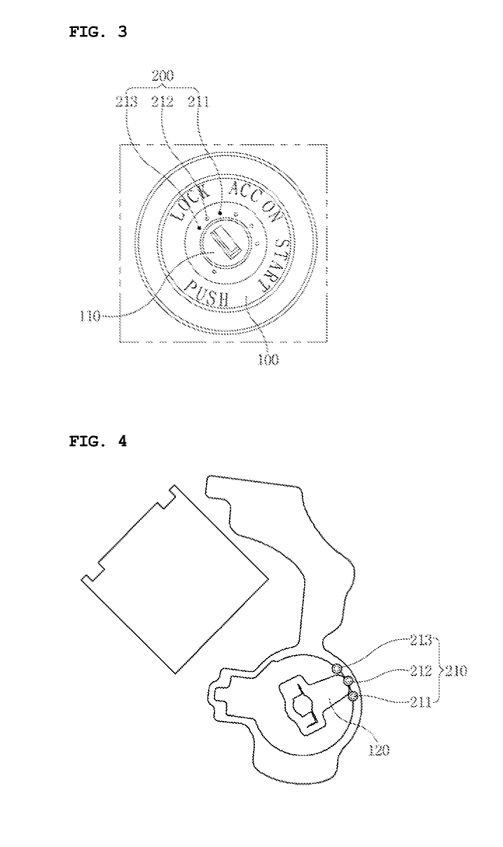

Meanwhile, the lock LOCK 210 of the ignition switch 200 is divided into a first lock 211 locking all doors, a second lock 212 unlocking only a driver's side door, and a third lock 213 unlocking all doors, as shown in FIGS. 3 and 4.

Referring to FIG. 4, the first lock 211, the second lock 212, and the third lock 213 are disposed on an inner peripheral surface of the lock cylinder at substantially equal intervals, respectively. Therefore, the connecting rod 120 contacts the first lock 211, the second lock 212, and the third lock 213 while being rotated, thereby sensing the signal.

In addition, each of the first lock 211, the second lock 212, and the third lock 213 is displayed by a symbol along a main surface of the rotor 110 in the lock cylinder 100. That is, the third lock 213, the second lock 212, the first lock 211, the accessory ACC, the on ON, and the start START are sequentially displayed in the lock cylinder 100 to increase usability of the driver.

That is, the connecting rod 120 is positioned at any one of the first lock 211, the second lock 212, and the third lock 213, such that the ignition switch 200 outputs a signal so as to selectively lock all doors, unlock only the driver's side door, or unlock all doors.

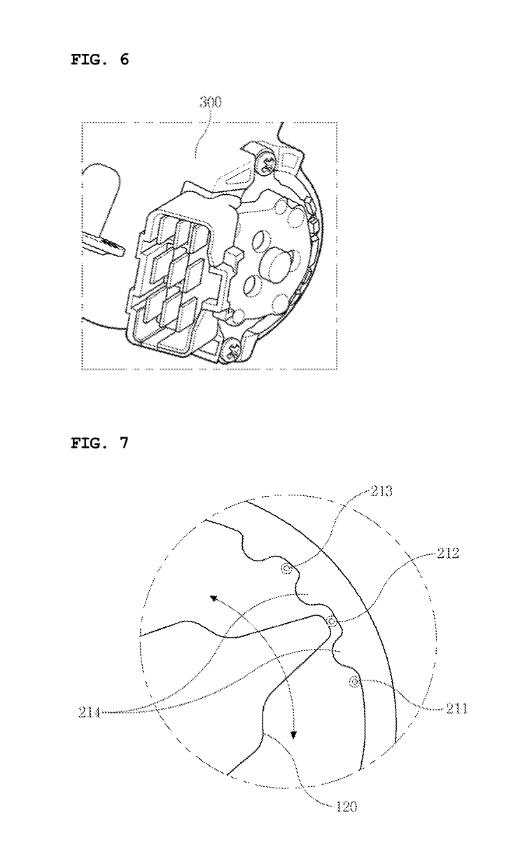

In addition, as shown in FIG. 6, the ignition switch 200 further includes three pins connected to the first lock 211, the second lock 212, and the third lock 213 to configure a nine pin connection terminal, thereby transferring a more accurate output signal to the BCM 300.

Hereinafter, logics of the smart door unlock system according to various embodiments of the present invention having the above-mentioned structure will be described in more detail.

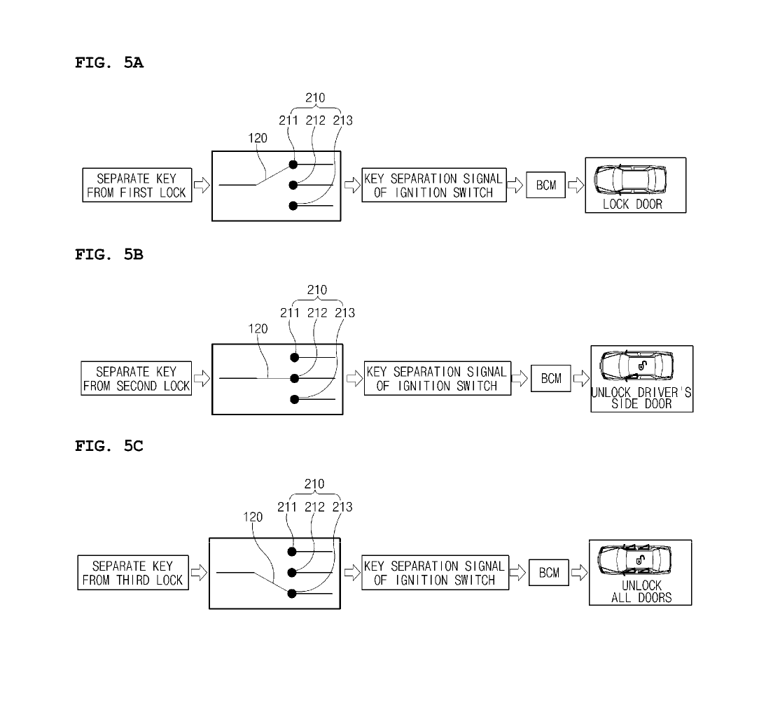

FIG. 5A illustrates a logic for a case at the time of separation of the key from the first lock. As shown in FIG. 5A, in the case of rotating the key in the state in which it is inserted into the rotor 110 and then separating the key in the state in which the connecting rod 120 is positioned at the first lock 211, a lock signal of all doors is output together with a key separation signal by the ignition switch 200. Therefore, an ignition is turned off, and at the same time, the BCM 300 maintains all doors in a lock state so as not to be opened.

FIG. 5B illustrates a logic for a case at the time of separation of the key from the second lock. As shown in FIG. 5B, in the case of rotating the key in the state in which it is inserted into the rotor 110 and then separating the key in the state in which the connecting rod 120 is positioned at the second lock 212, an unlock signal of a driver side door is output together with the key separation signal by the ignition switch 200. Therefore, the ignition is turned off, and at the same time, the BCM 300 automatically unlocks only the driver's side door so as to be opened and maintains the remaining doors in a lock state so as not to be opened.

FIG. 5C illustrates a logic for a case at the time of separation of the key from the third lock. As shown in FIG. 5C, in the case of rotating the key in the state in which it is inserted into the rotor 110 and then separating the key in the state in which the connecting rod 120 is positioned at the second lock 213, an unlock signal of all doors is output together with the key separation signal by the ignition switch 200. Therefore, the ignition is turned off, and at the same time, the BCM 300 automatically unlocks all doors so as to be opened.

As described above, the driver selectively locks or unlocks the door according to the usage, thereby making it possible to improve security and efficiency.

Hereinafter, in describing other exemplary embodiments of the present invention, the same or similar components will be denoted by the same or similar reference numerals, and an overlapped description will be omitted.

FIG. 7 is a view showing a door unlock system according to various embodiments of the present invention. The door unlock system according to various embodiments may include one or more catching jaws 214, formed between or among the first lock 211, the second lock 212, the third lock 213, as shown in FIG. 7. For example, a catching jaw may be formed between the first lock and the second lock and/or a catching jaw formed between the second lock and the third lock. The catching jaws 214 provide a catching feeling in the case in which the connecting rod 120 moves from the first lock 211 to the second lock 212 and from the second lock 212 to the third lock 213. Therefore, a position of the connecting rod 120 may be sensed without being confirmed with eyes. Further, the connecting rod 120 is caught so as to be stably positioned at the first lock 211, the second lock 212, or the third lock 213, such that movement of the connecting rod 120 due to unnecessary power is prevented.

According to various embodiments of the present invention, a system allowing all doors to be unlocked, allowing only a driver's side door to be unlocked, or allowing all doors to be maintained in a lock state by selection of the driver in a process of turning off the ignition is implemented, thereby making it possible to improve security.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A smart door unlock system comprising:
a lock cylinder including a rotor receivably having a key inserted thereinto and rotated and a connecting rod rotated together with the rotor;
an ignition switch provided with lock LOCK, accessory ACC, on ON, or start START switches, and outputting a signal of an operation state when the rotor is rotated with the key inserted thereinto and the connecting rod is positioned at any one of the switches;
a body control module (BCM) automatically locking or unlocking a door or doors according to the signal output from the ignition switch when the connecting rod is positioned at the lock LOCK,
wherein the lock LOCK of the ignition switch includes a first lock for locking all doors, a second lock for unlocking only a driver's side door, and a third lock for unlocking all doors.

2. The smart door unlock system according to claim 1, wherein in a case of separating the key when the connecting rod is positioned at the first lock, an ignition is turned off, and at the same time, the BCM maintains all doors in a lock state so as not to be opened.

3. The smart door unlock system according to claim 1, wherein in a case of separating the key when the connecting rod is positioned at the second lock, an ignition is turned off, and at the same time, the BCM automatically unlocks only the driver's side door so as to be opened and maintains other doors in a lock state so as not to be opened.

4. The smart door unlock system according to claim 1, wherein in a case of separating the key when the connecting rod is positioned at the third lock, an ignition is turned off, and at the same time, the BCM automatically unlocks all doors so as to be opened.

5. The smart door unlock system according to claim 1, wherein the lock cylinder includes symbols displaying the first lock, the second lock, or the third lock of the lock LOCK.

6. The smart door unlock system according to claim 1, further comprising a catching jaw or catching jaws formed between the first lock and the second lock or between the second lock and the third lock.
